(19) United States
(12) Patent Application Publication
(10) Pub. No.: US 2002/0195308 A1
(43) Pub. Date: Dec. 26, 2002

(54) Granular material transfer conveyor

(75) Inventors: Kimball Lischynski, Saskatoon (CA); Murray Kosokowsky, Pilger (CA)

Correspondence Address: MICHAEL BEST & FRIEDRICH, LLP, 100 E WISCONSIN AVENUE, MILWAUKEE, WI, 53202, US

(73) Assignee: Highline Manufacturing Inc., Canada

(21) Appl. No.: 09/885,179

(22) Filed: Jun. 20, 2001

(51) Int. Cl. B65G 13/00

(52) U.S. Cl. 193/37

(57) ABSTRACT

Disclosed is a novel transfer conveyor for transporting material from a feed point to an input section of a main conveyor. The transfer conveyor comprises a feed end, a discharge end, and a means for conveying material from the feed end to the discharge end. A connector is provided for detachably and rotatably connecting the transfer conveyor to the main conveyor such that the feed end of the transfer conveyor may be moved about the input section of the main conveyor while maintaining the flow of material from the discharge end of the transfer conveyor into an input section of the main conveyor. The transfer conveyor may be provided with a nozzle portion on the discharge end thereof to which the connector is attached. The transfer conveyor may also be provided with an undercarriage that is moveable between a compact storage position and a support position wherein the discharge end of the transfer conveyor is positioned at an elevated position relative to the feed end such that the transfer conveyor is operable as a stand alone conveyor. In addition, transfer conveyor may also include means for mounting the transfer conveyor on the main conveyor in a transport position wherein the transfer conveyor is suspended under the main conveyor.

### FIELD OF INVENTION

The invention relates to an improved apparatus for conveying granular material to the input section of a main conveyor.

### BACKGROUND

It is known to use transfer conveyors to convey granular material from a remote location to the input section of a main conveyor. Transfer conveyors are typically shorter than main conveyors and are often adopted to reach under bottom dumping bins or trucks.

Freestanding transfer conveyors are known. Such conveyors are generally manually positioned such that the input section is placed in the desired location and the output is positioned such that granular material discharged therefrom is deposited into a desired location such as the input section of the main conveyor. It is known to provide such conveyors with wheels to facilitate movement. However, when entirely disconnected from the main conveyor, difficulty may be encountered in positioning freestanding transfer conveyors to ensure the material is discharged into the main conveyor without spillage. Further, such conveyors may not be easy to rotate about the input section of the main conveyor without disrupting alignment between the discharge section of the transfer conveyor and the input section of the main conveyor.

It is also known to permanently attach transfer conveyors to main conveyors. Typically, such transfer conveyors will have an operating position where granular material discharged from the transfer conveyor is deposited into the input section of the main conveyor and a transport position wherein the transfer conveyor is positioned along the main conveyor. One such conveyor is shown in Canadian Patent No. 2,196,475 which discloses a transfer conveyor connected to a main conveyor by means of a connection assembly mounted on a track positioned above the main conveyor. The connection assembly permits rotation of the transfer conveyor about the input section of the main conveyor when in operation. However, the transfer conveyor cannot easily be disconnected from the main conveyor for operation in a freestanding position.

### SUMMARY OF INVENTION

It is an object of the invention to provide an improved transfer conveyor. According to a broad aspect of the invention, the invention provides a transfer conveyor for transporting material from a feed point to an input section of a main conveyor, said transfer conveyor comprising a feed end; a discharge end; a means for conveying material from the feed end to the discharge end; and a connector for detachably and rotatably connecting the transfer conveyor to the main conveyor such that the feed end of the transfer conveyor may be moved about input section of the main conveyor while maintaining the flow of the material from the discharge end of the transfer conveyor into an input section of the main conveyor.

According to another aspect of the invention aspect of the invention, the transfer conveyor includes a nozzle portion mounted on the discharge end thereof and the connector comprises a male member mounted within the nozzle portion and the female member mounted within the input section of the main conveyor, said female member adapted to releasably receive the male member.

According to yet another aspect of the invention, the transfer conveyor is provided with an undercarriage that is moveable between a compact storage position and a support position wherein the discharge end of the transfer conveyor is positioned at an elevated position relative to the feed end such that the transfer conveyor is operable as a stand-alone conveyor.

According to final another aspect of the invention, the transfer conveyor includes transfer connectors for mounting the transfer conveyor on the main conveyor in a transport position wherein the transfer conveyor is suspended under the main conveyor.

The invention provides an improved transfer conveyor that can be connected to the input section of a main conveyor such that material discharged from the transfer conveyor is deposited into the input section of the main conveyor. The connection between the main conveyor and the transfer conveyor permits the transfer conveyor to be rotated about the input section of the main conveyor without disrupting the alignment between the transfer conveyor output and the main conveyor input. Furthermore, the transfer conveyor can be disconnected from the main conveyor and operated in a freestanding position. Moreover, the transfer conveyor can be mounted on the main conveyor for transport.

### BRIEF DESCRIPTION OF THE DRAWINGS

Preferred embodiments of the invention will now be described by way of example with reference to the attached drawings in which:

FIG. 1 is partially exploded perspective view of a transfer conveyor according to an embodiment of the invention;

FIG. 2 is a right side view of a transfer conveyor according to an embodiment of the invention;

FIG. 3 is a partially exploded perspective view of a transfer conveyor according to an embodiment of the invention;

FIG. 4 is an exploded perspective view of a belt drive system according to an embodiment of the invention

FIG. 5 is a perspective view of a connection assembly according to an embodiment of the invention;

FIG. 6 is a perspective front view of the nozzle of the transfer conveyor disengaged from the connection assembly according to an embodiment of the invention;

FIG. 7 is a perspective side view of the input section of a main conveyor with the connection assembly mounted therein according to an embodiment of the invention;

FIG. 8 is a left side view of a transfer conveyor according to an embodiment of the invention;

FIG. 9 is a perspective view of a support assembly according to an embodiment of the invention; and

FIG. 10 is a side view of a transfer conveyor according to an embodiment of the invention mounted in the transport position under a main conveyor;

### DETAILED DESCRIPTION OF PREFERRED EMBODIMENTS

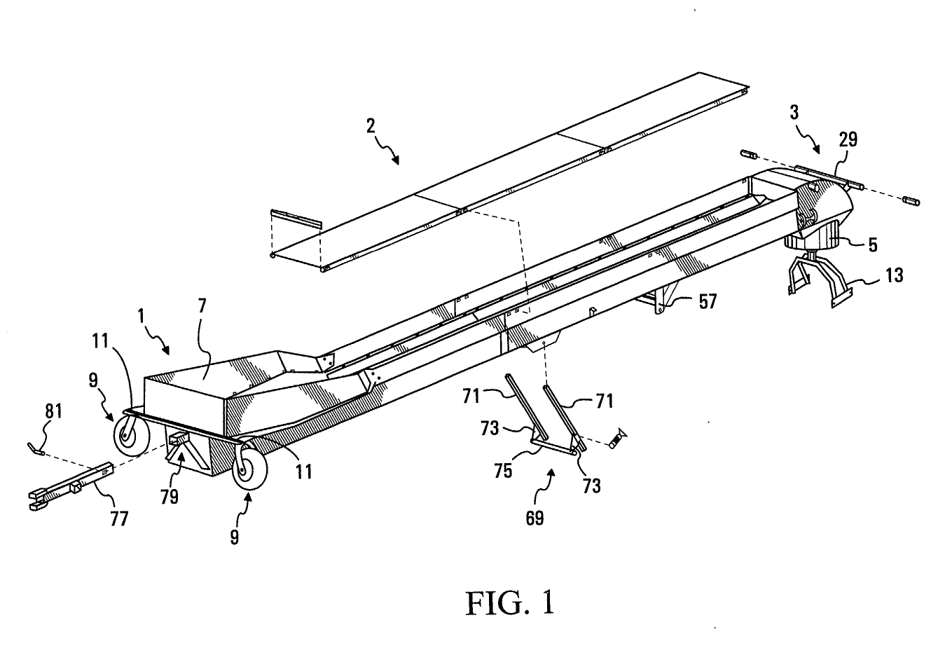

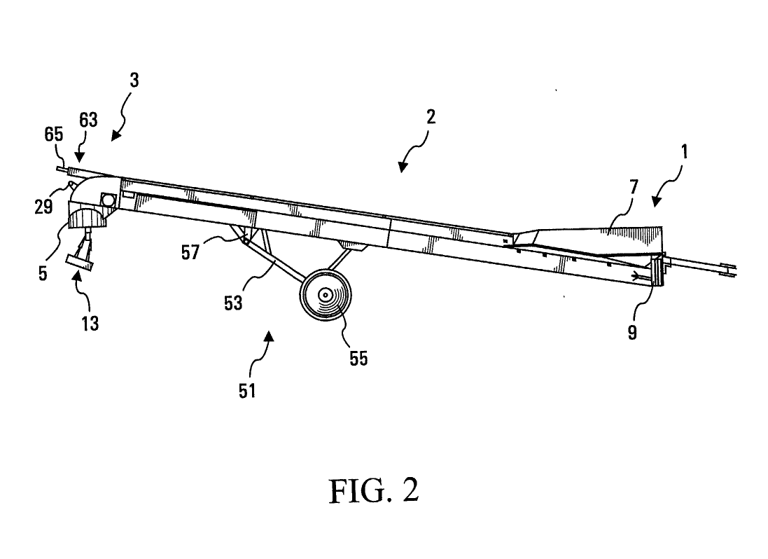

FIGS. 1 and 2 show a transfer conveyor 2 according to one embodiment of the invention. The transfer conveyor 2 has a feed section 1 and a discharge section 3 with a nozzle 5. A hopper 7 is mounted on the feed section 1 and is adapted to receive granular material from a seed source, such as a truck or hopper, and to direct the granular material onto a conveyance device. The granular material is then conveyed to the discharge section 3 and discharged out of nozzle 5.

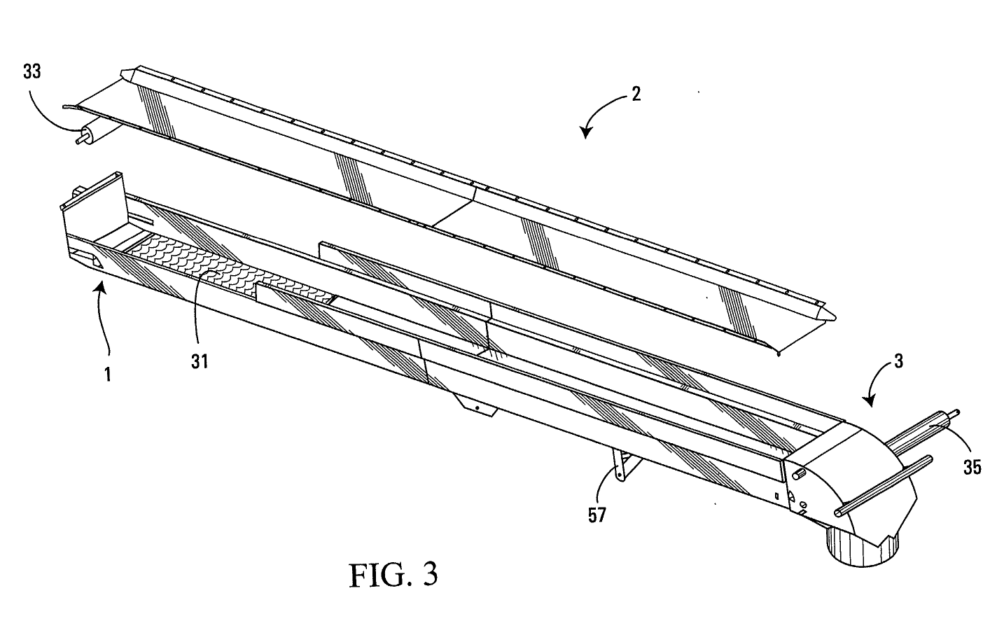

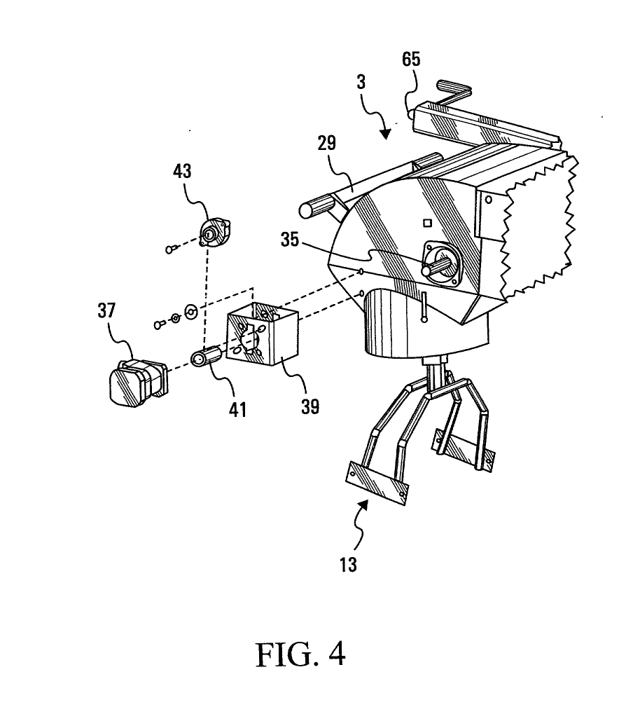

In the embodiment shown in the drawings, as can be seen in FIG. 3, the conveyance device comprises a conventional conveyor belt 31 mounted in the transfer conveyor 2 and adapted to transport granular material from the feed section 1 to the discharge section 3. The belt runs between two rollers 33 and 35 mounted within the transfer conveyor 2 at opposite ends thereof. The belt conveyor is driven by a motor 37 as shown in FIG. 4.

In the embodiment shown in FIG. 4, a hydraulic motor is illustrated. However, it will be understood that any conventional motor or other power source may be used. The motor 37 is connected to the discharge section 3 of the transfer conveyor 2 by a motor mount 39. The motor is attached to roller 35 by a coupler 41 that transfers the rotation of the motor 37 to the roller 35. A bearing 43 is mounted within the motor mount 39 to provide support to the roller 35 while permitting rotation thereof. It will be understood that any other conventional mounting means may be used to attach the motor or other power source.

Although the drawings show a specific embodiment of the conveyance device, it will be understood that alternative embodiments of the conveyance device may be used without departing from the invention in its broadest aspect. For example, the motor 37 could be arranged to drive roller 33 instead of roller 35. Alternatively, the motor 37 could be replaced by a belt or gear driving arrangement. Furthermore, an alternative type of conveyor device such as a screw type conveyor or a belt and screw conveyor combination may be used.

As illustrated in FIG. 1, wheels 9 are mounted to the feed end 1 of the transfer conveyor 2 by a mounting assembly 11 such that the wheels caster about an axis substantially perpendicular to the ground. The rotation of the wheels 9 in this manner facilitates movement of the feed end 1 of the transfer conveyor 2 in any direction as the wheels 9 will caster into a position parallel to the direction of travel of the feed end.

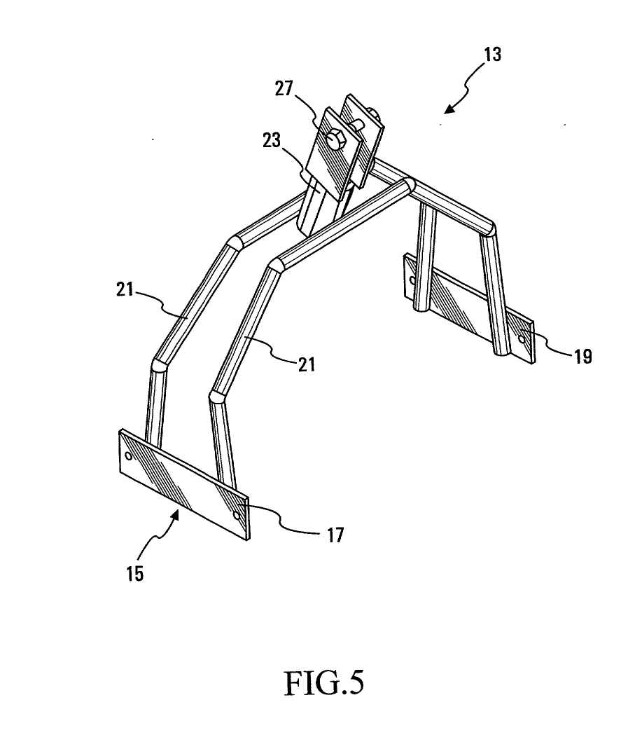

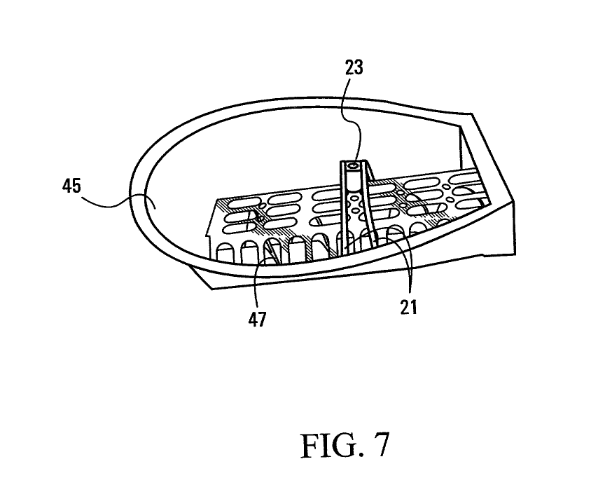

As illustrated in FIGS. 5 to 7, the nozzle 5 is provided with a connection assembly 13 for connecting the discharge end 3 of the transfer conveyor 2 to an input section of a main conveyor 45. The connection assembly 13 includes a bracket member 15 which is mounted within the input section of the main conveyor 45, as shown in FIG. 7, by a set of bracket plates 17 and 19 positioned at opposing ends thereof. A set of arms 21 extend in an arc shaped configuration between the bracket plates 17 and 19. A bushing 23 is mounted between the bracket arms 21 at the apex of the arc shaped configuration.

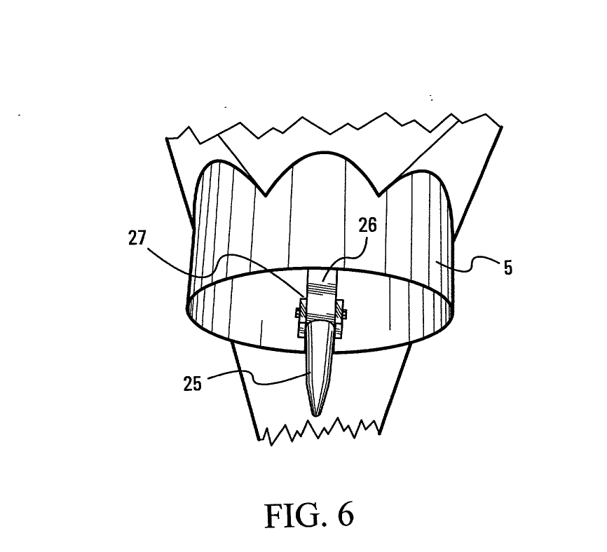

As illustrated in FIG. 6, the nozzle 5 is provided with a pin member 25 mounted in the center thereof by a bolt arrangement 27 which secures the pin member to a bar 26 which extends across the center of nozzle 5. The pin member 25 is sized to be detachably inserted within the bushing 23 while permitting rotation thereof within the bushing. Accordingly, the connection assembly supports the discharge end 3 of the transfer conveyor 2 while permitting rotation of the feed end 1 of the transfer conveyor 2 about the input section of the main conveyor 45 without disrupting the alignment of the nozzle 5 with the input section of the main conveyor.

The transfer conveyor 2 is disconnected from the input end of the main conveyor by lifting the discharge end 3 thereby removing the pin member 25 from the bushing 23.

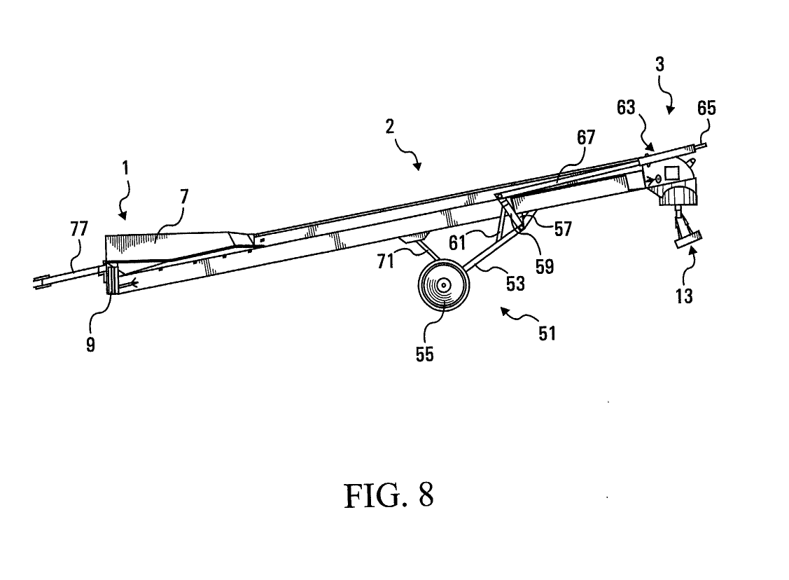

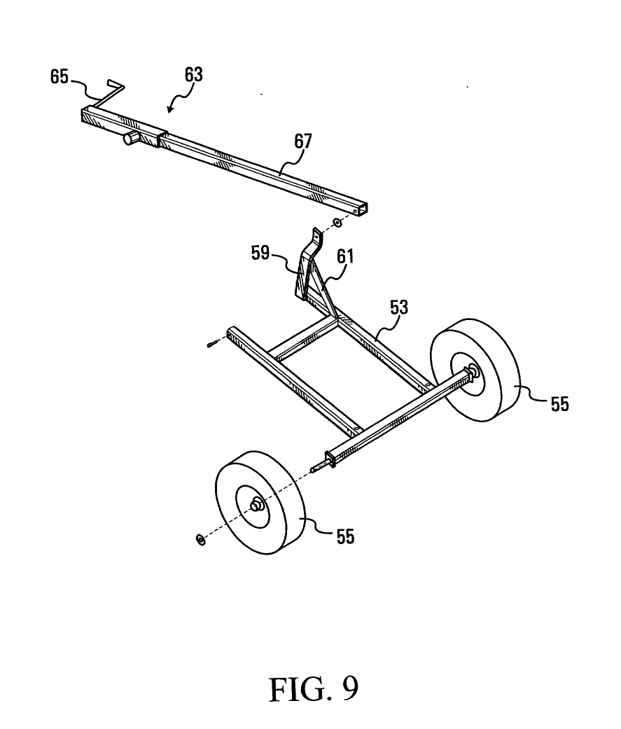

As shown in FIGS. 2 and 8, the transfer conveyor 2 is also provided with a retractable support assembly 51 to support the transfer conveyor when disconnected from the connection assembly 13 thereby permitting the transfer conveyor to be operated in a freestanding position. As best shown in FIGS. 8 and 9, the retractable support assembly includes an undercarriage 53 with a set of wheels 55 mounted thereon. The undercarriage 53 is pivotally attached to pivot members 57 positioned on the underside of the transfer conveyor 2 by means of a nut and bolt arrangement or the like. An arm member 59 is mounted on the left side of the undercarriage 53 and extends up along the side of the transfer conveyor. A support member 61 extends from the arm member 59 to the undercarriage 53 to maintain the arm member at the desired angle relative to the undercarriage 53.

The arm member 59 is also pivotally connected to a jack 63 mounted on the side of the transfer conveyor 2. The jack 63 includes a handle 65 and a reciprocating member 67. Rotation of the handle 65 causes the reciprocating member 67 to extend or contract along the axis of the jack 63 thereby raising or lowering the undercarriage 53.

The retractable support assembly 51 also includes a locking assembly 69 for supporting the undercarriage 53 when it is placed in a lowered position as shown in FIGS. 2 and 8. As shown in FIG. 1, the locking assembly 69 includes a set of locking arms 71 that have an end pivotally mounted to the underside of the transfer conveyor 2. The locking arms 71 each have a flange 73 extending at right angles therefrom with a handle 75 extending therefrom. As shown in FIGS. 2 and 8, when the undercarriage 53 is lowered, the locking assembly 69 pivots downwards where the locking arms 71 and flanges 73 engage the undercarriage. In this position, the locking assembly 69 provides support for the undercarriage 53.

To move the undercarriage 53 into a transport position, the locking assembly 69 is raised toward the underside of the transfer conveyor 2 where it is locked into position by a suitable locking mechanism (not shown). Once the locking assembly 69 is raised, the jack 63 can be used to lift the undercarriage 53 towards the underside of the transfer conveyor 2.

As shown in FIG. 1, the transfer conveyor 2 is also provided with a hitch assembly 77 at the feed end 1. The hitch assembly 77 has a T-shaped configuration with the upper portion thereof having one end adapted to be inserted into a bracket 79 mounted on the feed end 1. A pin 81 is inserted into the bracket 79 to maintain the hitch therein. The opposing end of the upper portion of the hitch assembly 77 is provided with a hitch for connection to an appropriate transporting device such as a tractor. The base portion of the T-shaped hitch assembly 77 is substantially shorter than the upper portion thereof and has an end adapted to be inserted into the bracket 79. Thus, when not in use, the base portion of the hitch can be inserted into the bracket 79 to put the hitch into a transport position.

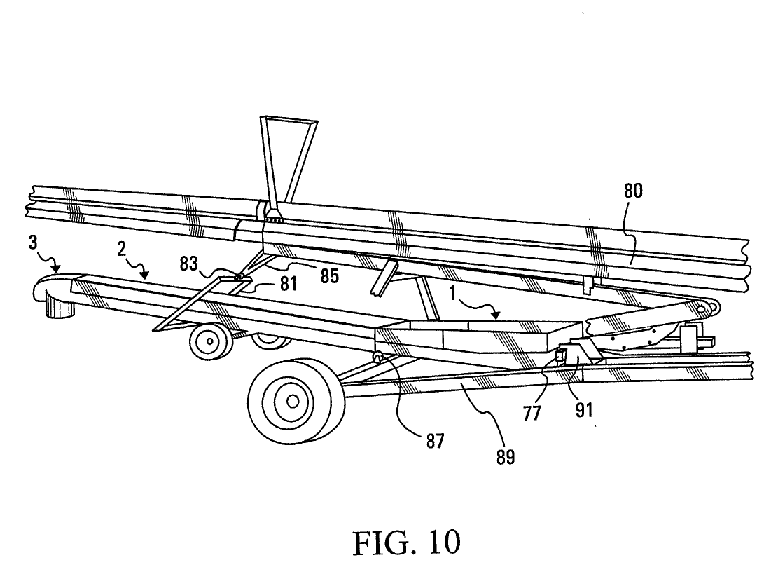

In an alternative to using the hitch assembly 77 to transport the transfer conveyor 2, the transfer conveyor 2 can be mounted underneath a main conveyor 80 for transport as shown in FIG. 10. As shown in the drawing, a U-shaped hook assembly 81 is pivotally attached to the pivot members 57. The hook assembly 81 includes a hook 83 which is attached to a bracket 85 mounted on the underside of the main conveyor 80. A roller 87 is mounted on the undercarriage 89 of the main conveyor 80. Positioned behind the roller 87 is a set of locking brackets 91 mounted on the undercarriage 89 which are adapted to receive the hitch assembly 77.

To mount the transfer conveyor 2 onto the main conveyor 80, the hitch assembly 77 is placed with the short base portion inserted into the bracket 79. The feed section 1 is raised and positioned on the roller 87 on the undercarriage 89 of the main conveyor 80. The transfer conveyor 2 is then pushed backwards along the undercarriage 89 of the main conveyor 80 until the hitch assembly 77 engages with the locking brackets 91. Once the feed end 1 is secured, the discharge end 3 of the transfer conveyor 2 can be raised such that the hook 83 can be attached to bracket 85 thereby maintaining the transfer conveyor 2 in the appropriate position.

It will be understood by those skilled in the art that numerous alterations, modifications and variations to the above embodiments can be made without departing from the invention as claimed.

We claim:

1. A transfer conveyor for transporting material from a feed point to an input section of a main conveyor, said transfer conveyor comprising:
(a) a feed end;
(b) a discharge end;
(c) a means for conveying material from the feed end to the discharge end; and
(d) a connector for detachably and rotatably connecting the transfer conveyor to the main conveyor such that the feed end of the transfer conveyor may be moved about input section of the main conveyor while maintaining the flow of the material from the discharge end of the transfer conveyor into an input section of the main conveyor.

2. An apparatus as claimed in claim 1 wherein the connector comprises:
(a) a male member; and
(b) a female member adapted to releasably receive the male member.

3. An apparatus as claimed in claim 2 wherein the discharge end of the transfer conveyor includes a nozzle portion and the male member is mounted within the nozzle portion and the female member is mounted within the input section of the main conveyor.

4. An apparatus as claimed in claim 3 wherein the male member comprises a pin mounted in the center of the nozzle portion and the female member includes a bushing adapted to permit rotation of the pin within the bushing about its longitudinal axis.

5. An apparatus as claimed in claim 4 wherein the bushing is mounted within the input section of the main conveyor by a bracket.

6. An apparatus as claimed in claim 3 wherein the feed end of the transfer conveyor includes a ground engaging low friction support member to facilitate movement of the feed about the input section of the main conveyor.

7. An apparatus as claimed in claim 6 wherein the ground engaging low friction support member comprises at least one caster wheel mounted at the feed end of the transfer conveyor.

8. An apparatus as claimed in claim 3 further comprising an undercarriage adapted to support the transfer conveyor.

9. An apparatus as claimed in claim 8 wherein the undercarriage is moveable between a compact storage position and a support position wherein the discharge end of the transfer conveyor is positioned at an elevated position relative to the feed end such that the transfer conveyor is operable as a stand-alone conveyor.

10. An apparatus as claimed in claim 9 wherein the undercarriage is lockable in the support position.

11. An apparatus as claimed in claim 10 further comprising low friction members on the undercarriage for engaging the ground when the undercarriage is in the support position.

12. An apparatus as claimed in claim 11 wherein the low friction members are wheels.

13. An apparatus as claimed in claim 9 further comprising a jack assembly connected to the undercarriage for moving the undercarriage between the compact storage position and the support position.

14. An apparatus as claimed in claim 3 further comprising transfer connectors for mounting the transfer conveyor on the main conveyor in a transport position.

15. An apparatus as claimed in claim 14 wherein the transfer conveyor is suspended under the main conveyor when in the transport position.

16. An apparatus as claimed in claim 15 wherein the main conveyor has an undercarriage and the transfer connectors comprise:
(a) mounting means for securing the feed end of the transfer conveyor on the undercarriage of the main conveyor; and
(b) a connecting member mounted to the transfer conveyor and having an end adapted to be connected to the main conveyor such that, when connected, the discharge end of the transfer conveyor is maintained at a position above the ground.

17. An apparatus as claimed in claim 16 wherein the connecting member is detachably connected to the transfer conveyor.

18. A transfer conveyor for transporting material from a feed point to an input section of a main conveyor, said transfer conveyor comprising:
(a) a feed end;
(b) a discharge end provided with a nozzle portion;
(c) a means for conveying material from the feed end to the discharge end; and
(c) a connector comprising a male member and a female member adapted to releasably receive the male member for detachably and rotatably connecting the transfer conveyor to the main conveyor such that the feed end of the transfer conveyor may be moved about input section of the main conveyor while maintaining the flow of the material from the discharge end of the transfer conveyor into an input section of the main conveyor;
(d) at least one ground engaging caster wheel mounted at the feed end of the transfer conveyor;
(e) an undercarriage moveable between a compact storage position and a support position wherein the discharge end of the transfer conveyor is positioned at an elevated position relative to the feed end such that the transfer conveyor is operable as a stand-alone conveyor, the undercarriage including wheels which engage the ground when the undercarriage is in the support position;
(f) transfer connectors for suspending the transfer conveyor under the main conveyor in a transport position.

19. An apparatus as claimed in claim 18 wherein the male member is mounted within the nozzle portion and the female member is mounted within the input section of the main conveyor and is adapted to permit rotation of the male member about its longitudinal axis.

20. An apparatus as claimed in claim 19 further comprising a jack assembly connected to the undercarriage for moving the undercarriage between the compact storage position and the support position.

21. An apparatus as claimed in claim 20 wherein the main conveyor has an undercarriage and the transfer connectors comprise:
(a) mounting means for mounting the feed end of the transfer conveyor on the undercarriage of the main conveyor; and
(b) a connecting member mounted to the transfer conveyor and having an end adapted to be connected to the main conveyor such that, when connected, the discharge end of the transfer conveyor is maintained at a position above the ground.
